(19) United States
(12) Patent Application Publication
(10) Pub. No.: US 2012/0066706 A1
(43) Pub. Date: Mar. 15, 2012

(54) SYSTEM AND METHOD FOR IMPROVING MEASUREMENT OF VIEWING PATTERNS BY SET TUNERS AND ADVERTISEMENT OPTIMIZATION

(76) Inventor: Andrew G. Setos, Pacific Palisades, CA (US)

(21) Appl. No.: 12/879,440

(22) Filed: Sep. 10, 2010

(51) Int. Cl. H04N 7/16

(52) U.S. Cl. 725/14

(57) ABSTRACT

A system and method for improving measurement of viewing patterns by set tuners and advertisement optimization are described. The present disclosure presents an improvement to existing set tuners that uses an uploaded application code to expand the reporting capabilities of pre-existing set tuners. The present disclosure also presents a method for increased optimization of advertising by correcting inefficiencies of existing set tuners and, optionally, further analyzing psychographics or demographics in conjunction with improved, non-invasive reporting mechanisms.

### BACKGROUND

The present disclosure relates to improvement of the measurement of viewing patterns by set tuners, such as set top boxes, and improvement of advertisement optimization as it relates to such viewing.

Current media delivery systems, e.g., cable television, satellite television, telecommunications, etc., use set tuners, e.g., set top boxes (“STBs”), for consumer end delivery of such media. These set tuners generally include software that monitors what channels the set top boxes are tuned to over a given time period and reports such information to a headend or central office for processing. There are hundreds of millions of existing set tuners in the United States alone that potentially provide a reporting service indicating the channel that the set tuner is tuned to at a given point in time. One known service that uses its own hardware independent of set top boxes, for analyzing such reports is the audience measurement system deployed by Nielson Media Research.

The sample size of current audience measurement is 4 orders of magnitude smaller than the number of set tuners, providing at best an overly coarse estimate of viewing. The present disclosure recognizes that a problem lies in the fact that while set tuners can report what channel that they are tuned to, they do not now report if the TV is turned on or if the volume is muted. This is not surprising, as it is not within the function of the set tuner to know or control these features. Without at least that information (power and sound on/off), any measurement is hopelessly inaccurate in that all it measures is what the last channel tuned was, not if the television is on or that the sound is on.

An exemplary analysis of traditional Neilson audience measurement for a broadcaster follows. A Neilson rating uses direct measurement of the content, not tuning, to generate an indication of viewers per channel (v/ch). In each Nielson home, Neilsen installs its own hardware to determine the state of the equipment and uses its own means to determine what program the viewer has selected.

It is impractical and uneconomic to extend this approach to all homes that use set top boxes. Given the 150 channels, on average, accessed by set top boxes, we see the small Neilsen sample as less than ideal for measuring viewing. However, using set top boxes alone without the invention would lead to unacceptable inaccuracies.

As is noted above, the inaccuracies of existing set tuners lies in the fact that the tuners only report what channel a set tuner is tuned to at a certain point in time. However, while the tuner may be tuned to a channel and may report that the channel is being viewed over a certain time period, the television could be off, or the audio could be muted. This generates an inherent inaccuracy in the reporting data, and consequently in the analysis.

Neilson has introduced a separate box for consumer use to further refine or verify data, including a stand-alone box connected to a telephone line to detect television on/off state or audio on/off state. However, these systems are cumbersome and intrusive, requiring, e.g. for audio state measurement, encoding of a watermark or other signal in an audio feed of the set tuner audio and pickup of sound by the standalone box at a speaker for analysis.

What is needed in the art is a non-intrusive improvement in reporting of viewer data by existing set tuners and corresponding improvement in advertising optimization resultant from analysis of that data.

### SUMMARY

The above-described and other problems and deficiencies of the prior art are overcome and alleviated by the presently described system and method for improving measurement of viewing patterns by existing set tuners, e.g., set top boxes, and advertisement optimization. The present system and method builds upon the capabilities of existing set tuners that can report, via an application running on the set tuner, the channel that the set tuner is tuned to. According to the present system and method, a supplemental application is uploaded to the existing set tuner, which application monitors a wireless detector (e.g., an infra-red detector) that is built in to the set tuner. The supplemental application compares a monitored wireless signal to a database of signals provided with the supplemental application or accessible by the supplemental application to determine a hardware state of additional non-set tuner devices (e.g., the on/off state of a television, the on/off state of an audio system, etc.). The supplemental application then reports such non-set tuner hardware state for a given time period.

In exemplary embodiments, a report processing application combines the standard report generated by the set tuner (including set tuner channel state) with the supplemental report to generate a file combining the report data. In exemplary embodiments, the generated file is then sent to a central office or a headend over a network for generation of improved viewing patterns and advertisement optimization.

In exemplary embodiments, psychographic and/or demographic information may be combined with the data at the central office or headend to improve advertisement optimization.

The above-discussed and other features and advantages of the presently described system and method will be appreciated and understood by those skilled in the art from the following detailed description and drawings.

### BRIEF DESCRIPTION OF THE DRAWINGS

Referring now to the drawings, wherein like elements are numbered alike in the following FIGURES:

FIG. 1 is a plan view of an exemplary system for improving measurement of viewing patterns by set tuners and advertisement optimization; and

FIG. 2 is a flow chart illustrating an exemplary method for improving measurement of viewing patterns by set tuners and advertisement optimization.

### DETAILED DESCRIPTION OF EXEMPLARY EMBODIMENTS

Reference will now be made in detail to exemplary embodiments, examples of which are illustrated by the accompanying drawing. As was noted above, the present disclosure relates to a system and method for improving measurement of viewing patterns by set tuners, e.g., set top boxes, and advertisement optimization. As is used herein, the term “set tuners” refers to devices that traditionally measure consumer viewing by reporting the channel(s) the tuner is tuned to at any given time. Accordingly, e.g., television tuners incorporating such a reporting application and set top boxes similarly incorporating such a reporting application are included within the scope of that term. While exemplary embodiments describing “set top boxes” are described herein, it should be understood that the present disclosure relates more generally to tuning devices that also report channel selections. Similarly, the present disclosure contemplates reporting with regard to any media, including without limitation, broadcast television, satellite or cable television, internet delivered media, etc.

The present system and method builds upon the capabilities of existing set tuners that can report, via an application running on the set tuner, the channel that the set tuner is tuned to. According to the present system and method, a supplemental application is uploaded to the existing set tuner, which application monitors a wireless detector (e.g., an infra-red detector) that is built in to the set tuner. The supplemental application compares a monitored wireless signal to a database of signals provided with the supplemental application, accessible by the supplemental application or learned by the supplemental application or set tuner to determine a hardware state of additional non-set tuner devices (e.g., the on/off state of a television, the on/off state of an audio system, etc.). The supplemental application then reports such non-set tuner hardware state for a given time period.

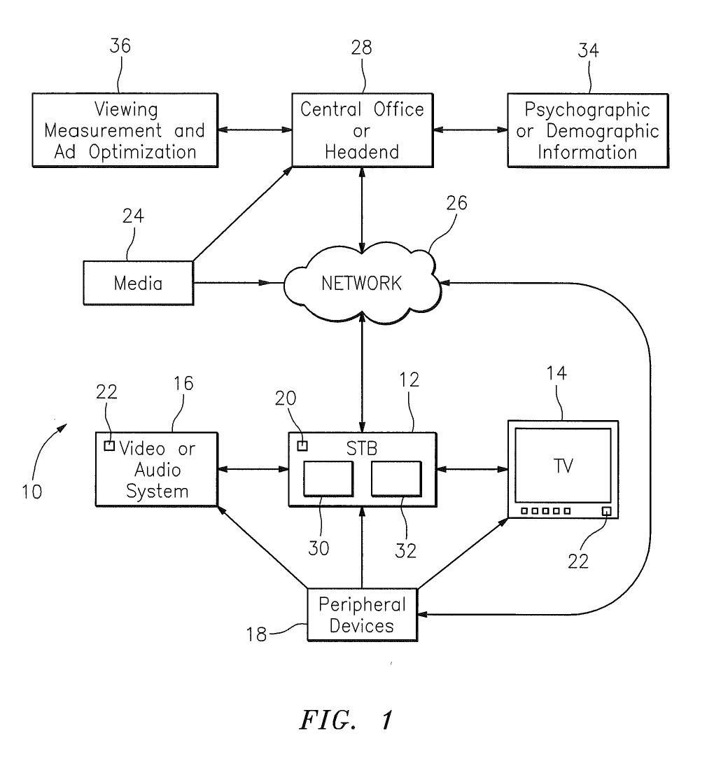

Referring now to FIG. 1, an exemplary system for improving measurement of viewing patterns by set tuners is illustrated generally at 10. The exemplary system includes a set tuner 12, a television 14 and a video or audio system 16. The system need not include any specific type or amount of standalone equipment, so long as at least one non-set tuner is associated with the set tuner. For example, the system may include simply a television 14 and set tuner 12, instead of including separate audio/video components. Additionally, the system may include more discrete components than are illustrated.

The system also includes at least one wireless peripheral device 18, such as a remote control, a computer, a handheld device, such as an iPod, telephone or PDA, a tablet device, such as an iPad, etc. The wireless device includes at least one wireless mechanism for which the set tuner is configured to monitor, e.g., infrared for most types of current remote controls, Bluetooth, radio-frequency transmission, etc. Further, the peripheral device may communicate with the set top device via a wireless network protocol, and may communicate with external media itself through a network, e.g., by a home system gateway common to the set tuner and the peripheral device.

As is illustrated in FIG. 1, the set tuner includes wireless monitoring hardware 20, e.g., an infrared port. Non-set tuner components similarly include wireless monitoring hardware 22.

In an exemplary embodiment, the set tuner 12 receives media 24, such as television programming, etc., through a network 26. The set tuner 12 reports the channel to which the set tuner is tuned via a first, standard application 30 native to the set tuner. This report data is traditionally reported to a control office or headend 28 for analysis of viewing of channels over a given time period.

The present invention provides a second, supplemental application 32 to the set tuner 12, which application monitors the wireless monitoring hardware 20 of the set tuner. The supplemental application compares the monitored wireless signal against a database of signals provided with, accessible by the supplemental application or learned by the supplemental application or set tuner to determine a state change of non-set tuner hardware. Thus, in one exemplary embodiment, a learning function guides the consumer through a setup procedure to “turn on”, “turn off” etc, their equipment and will store the new information in the database 20. Accordingly, the supplemental application uses already built-in hardware for the set tuner to expand reporting capabilities of existing set tuners from simple reporting of channel state to also include any non-set tuner hardware state as is desired or advantageous for improving measurement of viewing patterns.

Referring still to FIG. 1, in exemplary embodiments, a report processing application combines the standard report generated by the native application 30 on the set tuner 12 (including set tuner channel state) with the supplemental report generated by the supplemental application 32 on the set tuner 12 to generate a file combining the report data. In exemplary embodiments, the generated file is then sent to a central office or a headend 28 over a network f26 or generation of improved viewing patterns and advertisement optimization.

In exemplary embodiments, psychographic and/or demographic information 34 may be combined with the data at the central office or headend 28 to improve advertisement optimization 36.

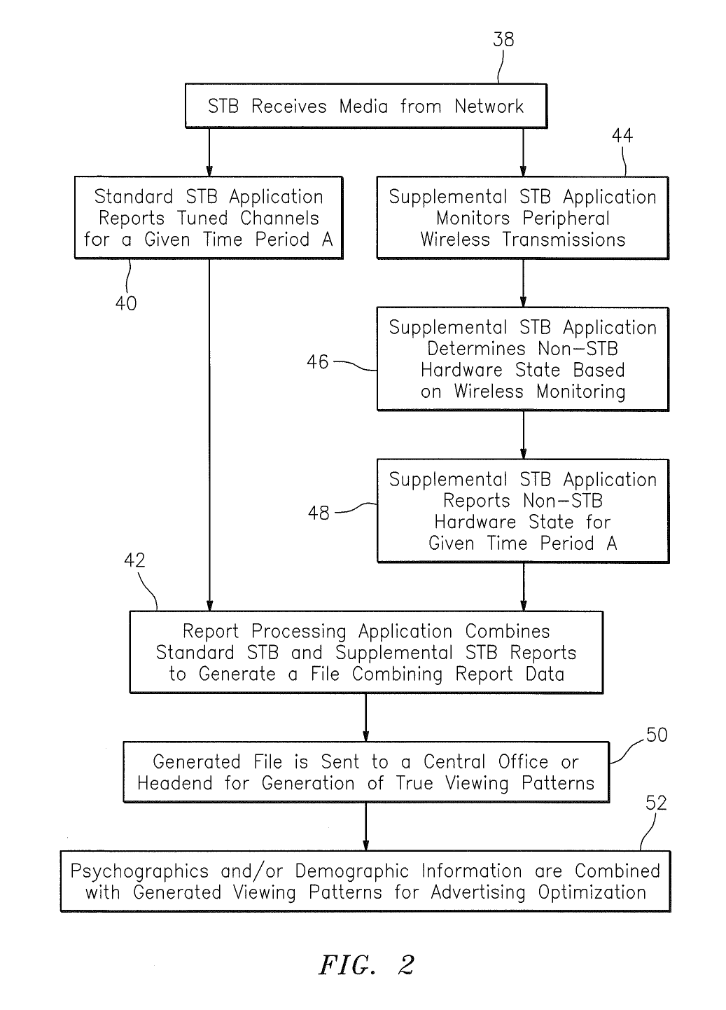

FIG. 2 illustrates a flow chart for an exemplary method for improving measurement of viewing patterns by existing set tuners and for advertising optimization. As is evident from the flow chart, a set tuner is configured to receive media from a network at 38, e.g., through a residential gateway or otherwise. At 40, the set tuner is natively configured with a standard, native application that reports tuned channels for a given time period (A). This report is traditionally provided to a report processing application within the set tuner or at a central office or headend for generation of viewing patterns based on the channel state.

Referring still to FIG. 2 at 44, a supplemental set tuner application is uploaded to the set tuner, which application monitors peripheral wireless transmissions. At 46, the supplemental application determines a state of a non-set tuner hardware device based on such wireless signal monitoring. At 48, the supplemental application reports the non-set tuner hardware state for a given time period (e.g., time period A, corresponding to the time period reported by the native, channel state application).

Referring to FIG. 2 at 42, an exemplary report processing application combines the native, channel state application report with the supplemental report including the hardware state of at least one non-set tuner device to generate a file containing report data. This application can be uploaded to the set tuner for user-side combination of report data, or this application can exist external to the set tuner, including at a central office or headend (i.e., separate reporting data can be passed all the way to the central office or headend before being combined into the analysis.

Referring to FIG. 2 at 50, the central office or headend generates improved viewing patterns relative to traditional systems. Also, at 52 in FIG. 2, psychographics and/or demographics may be combined, in an exemplary method, with the generated viewing patterns via an application for additional advertising optimization. In exemplary embodiments, such psychographic and/or demographic information may be pulled from the headend or related source, such as from subscriber or user account database information or other relevant user information. Where such additional information is combined with the tuning box reported information, exemplary embodiments contemplate anonymous convolution of the data, e.g., to protect the privacy of individual users or subscribers, such that the rendered measurement information may be known only in the aggregate.

Accordingly, the present disclosure presents an improvement to existing set tuners that uses an uploaded application code to expand the reporting capabilities of pre-existing set tuners (in an economically feasible manner). The present disclosure also presents a method for increased optimization of advertising by correcting inefficiencies of existing set tuners and, optionally, further analyzing psychographics or demographics in conjunction with improved, non-invasive reporting mechanisms.

It will be apparent to those skilled in the art that, while exemplary embodiments have been shown and described, various modifications and variations can be made to the present system and method disclosed herein without departing from the spirit or scope of the invention. Accordingly, it is to be understood that the various embodiments have been described by way of illustration and not limitation.

What is claimed is:

1. A system for improving measurement of viewing patterns by set tuners, comprising:
a set tuner configured with a channel reporting application, the set tuner also configured with a wireless signal monitoring device;
a separate hardware device connected to and receiving data from said set tuner; and
at least one wireless peripheral device,
wherein the set tuner also includes an uploaded supplemental application configured to report a hardware state of said separate hardware device, said hardware state determined by a peripheral device wireless signal received by the wireless monitoring device, to supplement data reported by the channel reporting application and thereby improve upon the measurement of viewing patterns by the set tuner that would otherwise be limited to reporting of channel state information by the channel reporting application.

2. A system in accordance with claim 1, wherein said separate hardware device comprises a television, monitor, media receiver or audio hardware.

3. A system in accordance with claim 1, wherein said wireless peripheral device comprises an infrared remote control, a radio frequency remote control, a wifi device or a Bluetooth device.

4. A system in accordance with claim 1, further comprising a central office or headend connected to the set tuner via a network.

5. A system in accordance with claim 4, wherein said central office or headend is configured to receive reporting data from said channel reporting application and from said supplemental application.

6. A system in accordance with claim 5, wherein said central office or headend is configured to receive said reporting data from a separate, third application that convolves the data from said channel reporting application and from said separate application for reporting to the central office or headend.

7. A system in accordance with claim 5, wherein said central office or headend is configured to convolve reporting data from the set tuner with psychographic or demographic information residing at or accessible by said central office or headend for improved viewing pattern measurement.

8. A method for improving measurement of viewing patterns by set tuners, comprising:
providing a set tuner pre-configured with a channel reporting application, the set tuner also pre-configured with a wireless signal monitoring device;
providing a separate hardware device connected to and receiving data from said set tuner;
providing at least one wireless peripheral device; and
uploading a supplemental application to the set tuner, the supplemental application configured to report a hardware state of said separate hardware device, said hardware state determined by a peripheral device wireless signal received by the wireless monitoring device, to supplement data reported by the channel reporting application and thereby improve upon the measurement of viewing patterns by the set tuner that would otherwise be limited to reporting of channel state information by the channel reporting application.

9. A method in accordance with claim 8, comprising monitoring, via said supplemental application, said hardware state of said separate hardware device to determine a hardware state of said separate hardware device.

10. A method in accordance with claim 9, comprising reporting said hardware state to a central office or headend.

11. A method in accordance with claim 10, wherein said reporting via said supplemental application involves a third application that convolves the data from said channel reporting application and the data from said supplemental application.

12. A method in accordance with claim 8, wherein said separate hardware device comprises a television, monitor, media receiver or audio hardware.

13. A method in accordance with claim 8, said wireless peripheral device comprises an infrared remote control, a radio frequency remote control, a wifi device or a Bluetooth device.

14. A method in accordance with claim 10, wherein said a central office or headend is connected to the set tuner via a network.

15. A method in accordance with claim 10, comprising convolving reporting data from the set tuner with psychographic or demographic information residing at or accessible by said central office or headend for improved viewing pattern measurement.
